(19) United States
(12) Patent Application Publication
(10) Pub. No.: US 2011/0147592 A1
(43) Pub. Date: Jun. 23, 2011

(54) ARRANGEMENT ADAPTED FOR SPECTRAL ANALYSIS OF SMALL CONCENTRATIONS OF GAS

(76) Inventor: Hans Göran Evald Martin, Delsbo (SE)

(21) Appl. No.: 13/061,376

(22) PCT Filed: Aug. 25, 2009
(86) PCT No.: PCT/SE2009/050955

§ 371 Date: Feb. 28, 2011

(30) Foreign Application Priority Data
Aug. 28, 2008 (SE) 0801857-4

(51) Int. Cl. G01J 3/42; G01N 21/35

(52) U.S. Cl. 250/343

(57) ABSTRACT

This invention comprises an arrangement adapted for a spectral analysis, said arrangement having an IR (Infra Red light) transmitting means adapted for an electromagnetic radiation, a limited space in the form of a cavity serving as a measuring eel! and intended to be able to define an optical measuring distance or path, a sensing means for said electromagnetic radiation, passing said optical measuring distance from said transmitting means to said sensing means, and a unit performing the spectral analysis and connected at least to said sensing means. Said sensing means for the electromagnetic radiation is opto-electrically adapted sensitive to the electromagnetic radiation which is intended to fall within the spectra! area whose selected wavelength components or spectral elements are to become the subject of an analysis in the unit performing the spectral analysis, so as to determine in this unit, over calculations, the relative radiation intensity of the spectral element. Said electromagnetic radiation is adapted to be permitted to pass, with a predetermined energy, the space, in which the sample of gas is disposed, under a predetermined overpressure 1 such as an overpressure variable in time. A correction circuit is adapted to have a produced fictive measuring value reduced to a measuring value that is representative at atmospheric pressure.

### TECHNICAL FIELD OF THE INVENTION

This invention refers generally to an arrangement adapted for an electromagnetic radiation and for the evaluation of small concentrations of gas.

The practical application of the invention will be described more specifically in the following with reference to an arrangement adapted for gas or a gas meter or measuring unit with the purpose of determining the existence of a gas by means of this gas meter, wherein said gas can occur in the form of small concentrations of gas in a sample of gas adapted for said evaluation.

A gas-adapted arrangement of this type is then to exhibit an emitting or transmitting means adapted for electromagnetic radiation; a following restricted space, in the form of a cavity, serving as a measuring cell for a sample of gas and intended to be able to define an optical measuring distance or path applying to the measuring itself; a detecting or sensing means for said electromagnetic radiation passing said optical measuring distance from said transmitting means; and a unit performing a spectral analysis and connected at least to said sensing means.

Said means for sensing the electromagnetic radiation is adapted to be opto-electrically sensitive to the electromagnetic radiation which is intended to fall within a spectral field whose chosen wavelength component(s) or spectral element(s) is/are to be the subject of an analysis in the unit performing the spectral analysis so as to permit in this unit determining the relative intensity of radiation of the spectral element(s).

This technical field includes the transmitting means indicated and utilized here and earlier known sensing means together with units performing spectral analyses and for example display units connected thereto and presenting the results, and therefore these means, units and display units are not going to be the subject of a more specific study and illustration in this application with regard to their structural composition.

### BACKGROUND OF THE INVENTION

Methods, arrangements and structures related to the technical field and character mentioned above are known earlier in a plurality of different embodiments.

As a first example of the background of technology and the technical field to which the invention refers it may be mentioned an arrangement adapted for spectral analysis of a sample of gas, said arrangement having a transmitting means adapted for an electromagnetic radiation, a limited space, in the form of a cavity, serving as a measuring cell and intended to be able to define an optical measuring distance or path, a sensing means for said electromagnetic radiation passing said optical measuring distance from said transmitting means, and a unit performing spectral analyses of the sample of gas connected at least to said sensing means by using one or more opto-electrical detectors.

Said means sensing the electromagnetic radiation is opto-electrically adaptedly sensitive to the electromagnetic radiation which is intended to fall within a spectral field whose selected wavelength component(s) or spectral element(s) is/are to become the object of an analysis within the unit performing the spectral analysis so as to determine within this unit the relative radiation intensity of relevant and selected wavelength sections of the spectral element.

Reference is made to US patent publication U.S. Pat. No. 5,009,493, German patent publication DE-A1-4 110 653, US patent publication U.S. Pat. No. 5,268,782 and US patent publication U.S. Pat. No. 4,029,521 for illustrating the prior art.

As a more specific first example of the arrangement indicated here, analysing the sample of gas, reference is made to the contents of the published International Patent Application No. PCT/SE99/00145 (WO 99/41 592) comprising a method for producing a detector related to a gas sensor and a detector produced in this manner.

As a second more specific example of the arrangement indicated here reference is made to the contents of the published International Patent Application having publication number WO 97/18460.

As a third specific example of the arrangement indicated here reference is made to the contents of the published International Patent Application having publication number WO 98/09152.

In addition, reference is made to the contents of the International Patent Application having publication number WO 01/81 901.

If the characteristics associated with the present invention are considered it may be mentioned that it is known that the relative intensity of radiation of the spectral element(s) for relevant wavelength section(s) is low in small and very small concentrations of gas and that the achieved results have been shown to exhibit large margins of error.

In known spectral analyses a smallest (high) concentration of gas is normally required for on the one hand determining the relevant gas and on the other hand evaluating its relevant concentration of said selected gas or its gas mixture.

It is also known that the relative intensity of radiation of the spectral elements of relevant wavelength sections increases with an increased pressure of the sample of gas of relevant gas and/or mixture of gas; however, this increase depends on that a relevant gas and/or a relevant mixture of gas for this application is more or less dependent of prevailing pressure.

In considering the characteristics related to the present invention, utilizing different kinds of optical bandpass filters may also be noted as parts of the prior art.

Thus it is known to supply at right angles to a bandpass filter electromagnetic or optical radiation having a large wavelength area and to create within the filter prerequisites for passing a selected small wavelength area to an opto-electric detector for evaluating in this detector and in a connected unit, performing spectral analysis, the intensity of the narrow or small wavelength area and/or its relative intensity.

Such bandpass filter can also be supplied with electromagnetic radiation or optic radiation within an angular area, diverging from said perpendicular passing, with such bandpass filter being structured and/or constructed to create prerequisites for passing another chosen narrow wavelength areas.

Such bandpass filter will thus be able to offer a wavelength passage dependent of a chosen angle of incidence and transmission of the incident radiation through the used bandpass filter.

It is also known that for gases and/or gas mixtures of low concentration a high measuring accuracy is required, particularly at or adjacent to its zero point, in order to indicate an achieved result.

It is also known and described, from the European Patent Publication EP-0 557 655-A1, a system for collecting weakly shattered optical signals (100) and which system employs a laser (102), which illuminates an unknown gas (107) sample contained by a long hollow chamber (105) having an inner highly reflective coating (106 or 111).

This publication discloses that the illuminating electromagnetic radiation (103) from the laser (102) is directed along the entire length (“L”) of the long hollow chamber (105) and collides with vibrating molecules of the unknown gas within the chamber or a containment tube.

The collisions cause the emission of shifted electromagnetic radiation (112) that is separated from the incident light and than is collected through one of the apertures (108) of the chamber or tube.

The scattered photons are than guided to a collection optics assembly (16) and a photo detector (124).

This publication discloses means for minimizing interaction with said containment means (105), exposing exit means (108) for separating a shattered portion (112) of said beam of electromagnetic radiation (103) from an unshattered portion (104) of said beam of electromagnetic radiation (103) and that said containment means (105) is is to be allotted an inside diameter of at least 0.5 mm.

This publication discloses, in column 2, lines 31 to 37, that a factor “two” improvement involves an increase in the number density of the molecules distributed along the path of the stimulating beam. It is here suggested that the pressure is to be increased inside the sample cell or means (105).

However it is stated in that publication that such actions usually involves a significant increase in the complexity and cost of the apparatus.

### STATEMENT OF THE PRESENT INVENTION

### Technical Problem

If the circumstance is considered, that the technical considerations that a person skilled in the relevant technical art must carry out in order to offer a solution of one or more technical problems are on the one hand initially a necessary knowledge of the measures and/or a sequence of measures that are to be taken and on the other hand a necessary choice of the one or more means which are necessary, the following technical problems should because of this be relevant in presenting the present subject of invention.

Considering the earlier state of technology, as it is described above, it should therefore be seen as a technical problem to be able to understand the significance of, the advantages related to and/or the technical measures and considerations which will be necessary for offering, in an arrangement adapted for spectral analysis, a simple and cost-effective method of having the intensity of electromagnetic radiation or radiation of light spectrally analysed, for having a sample of gas analysed, such as with a low concentration of gas, within a limited space.

There is a technical problem in being able to understand the significance of, the advantages related to, and/or the technical measures and considerations which will be required for having prerequisites created for being able to achieve practically a high accuracy of measuring.

There is a technical problem in being able to understand the significance of, the advantages related to, and/or the technical measures and considerations which will be required for modifying measuring carried out with an external partial system adapted for compressing the measuring gas so as to thereby create a more distinct impairment of the amplitude.

There is a technical problem in being able to understand the significance of, the advantages related to, and/or the technical measures and considerations which will be required for modifying said transmitting means in the form of IR light (Infra Red light) to be maintained as constant at a predetermined energy level or at least essential constant and that the pressures of concentrations of the gas are set to vary is such a way that a modulated concentration of gas is to be adapted for creating or generating one or more differential signals, whereby a static IR signal of the environment can be subtracted away in a chosen signal processing.

There is a technical problem in being able to understand the significance of, the advantages related to, and/or the technical measures and considerations which will be required for being able to limit the amplification factor in the calculations of absorption so as to thereby be able to limit the effect of a noise factor or factors.

There is a technical problem in being able to understand the significance of, the advantages related to, and/or the technical measures and considerations which will be required for having prerequisites created for clarifying a zero point and/or a zero point error.

There is a technical problem in being able to understand the significance of, the advantages related to, and/or the technical measures and considerations which will be required for letting a source of IR light emit a constant continuous and pulsed light and modulate the pressure of the measuring gas with the purpose of thereby having a differential signal generated.

There is a technical problem in being able to understand the significance of, the advantages related to, and/or the technical measures and considerations which will be required for utilizing on the basis of an arrangement, having transmitting means adapted for electromagnetic radiation; a limited space surrounding the sample of gas in the form of a cavity serving as a measuring cell and intended to be able to define an optical measuring distance or path through a sample of gas; a sensing means for said electromagnetic radiation passing through said optical measuring distance or path from said transmitting means, and, at least one unit performing the spectral analysis and being connected to said sensing means, wherein said means sensing the electromagnetic radiation is adapted to be opto-electrically sensitive for the electromagnetic radiation which is intended to fall within (the wavelength component or) a spectral area whose selected spectral element(s) is/are to be the object of an analysis within the unit performing the spectral analysis so as in this unit to determine the (relative) radiation intensity of the spectral element(s) and to present this on a display unit or corresponding means, wherein it is possible, in simple manner and cost-effectively, to be able to spectrally analyse the intensity of components lying adjacent to each other in terms of wavelengths or spectral elements of a combined light of different wavelengths or an electromagnetic beam of light at compressed, such as low, concentrations of gas or gases.

There is a technical problem in being able to understand the significance of, the advantages related to, and/or the technical measures and considerations which will be required for measuring, under the prerequisites mentioned above, the mutual relations of signal intensities to each other and solely for specific and adjacent wavelength components and/or spectral elements.

There is a technical problem in being able to understand the significance of, the advantages related to, and/or the technical measures and considerations which will be required for letting a limited spectral analysis be adapted to a measuring technology within gas analysis and gas concentration measuring wherein a specific “spectral signature” or a “signal impression” is required for letting these be the basis of a matter-unique identification and/or content determining, at least in a low concentration of gas.

There is a technical problem in being able to understand the significance of, the advantages related to, and/or the technical measures and considerations which will be required for letting a small number of wavelength-specific measuring points or spectral elements, at least one wavelength point per matter, be the subjects of identification and/or surveillance.

There is a technical problem in being able to understand the significance of, the advantages related to, and/or the technical measures and considerations which will be required for letting electromagnetic bandpass filters be utilized for creating measuring signals at fixed predetermined wavelengths in accordance with the principles of a non-dispersive infrared technology (Non-Dispersive InfraRed or “NEAR” technique).

There is a technical problem in being able to understand the significance of, the advantages related to, and/or the technical measures and considerations which will be required for having said gas, in said measuring chamber or cell, set under a predetermined overpressure.

There is a technical problem in being able to understand the significance of, the advantages related to, and/or the technical measures and considerations which will be required for letting a delivered result, depending on one or more wavelengths in absorption within the measuring chamber or cell, be compensated over an adapted correction circuit for the influence of the chosen overpressure and a chosen gas or gas mixture for having a signal corresponding to the concentration of the relevant gas at atmospheric pressure delivered.

There is a technical problem in being able to understand the significance of, the advantages related to, and/or the technical measures and considerations which will be required for letting the overpressure selected beforehand be adapted and selected in dependence of the ability of absorption valid for a selected gas at the selected overpressure and/or a gas mixture.

There is a technical problem in being able to understand the significance of, the advantages related to, and/or the technical measures and considerations which will be required for letting said correction circuit be placed in cooperation with a correction unit with a circuit determining the absorption capacity/pressure of a selected gas or gas mixture.

There is a technical problem in being able to understand the significance of, the advantages related to, and/or the technical measures and considerations which will be required for letting the overpressure selected beforehand to be generated by mechanical means.

There is a technical problem in being able to understand the significance of, the advantages related to, and/or the technical measures and considerations which will be required for letting the mechanical means consist of a piston-cylinder-arrangement, the piston of which is adapted to move reciprocally between associated turning points in a cylinder unit.

There is a technical problem in being able to understand the significance of, the advantages related to, and/or the technical measures and considerations which will be required for letting the mechanical means consist of a magnetic body oriented inside or in relation to the measuring cell, said body being provideable with an oscillating motion by an oscillating electric circuit surrounding the body.

There is a technical problem in being able to understand the significance of, the advantages related to, and/or the technical measures and considerations which will be required for letting the frequency of a selected change of overpressure be selected to between 1 and 50 Hz, such as around 25-35 Hertz.

There is a technical problem in being able to understand the significance of, the advantages related to, and/or the technical measures and considerations which will be required for letting the measuring chamber be adapted to a volume of 0.5 to 3.0 cm³, such as around 0.8-1.2 cm³.

There is a technical problem in being able to understand the significance of, the advantages related to, and/or the technical measures and considerations which will be required for letting the increase of pressure be selected to between 1:2 and 1:10, such as around 1:4 to 1:6.

There is a technical problem in being able to understand the significance of, the advantages related to, and/or the technical measures and considerations which will be required for letting a correction circuit be adapted to deliver a signal or value of the gas concentration related to an atmospheric pressure.

There is a technical problem in being able to understand the significance of, the advantages related to, and/or the technical measures and considerations which will be required for letting said electromagnetic radiation, between said transmitting means and said sensing means, be adapted to pass a specifically adapted optical bandpass filter.

There is a technical problem in being able to understand the significance of, the advantages related to, and/or the technical measures and considerations which will be required for letting such bandpass filter be arranged, structured or constructed for being able to offer a wavelength dependent on the angle of incidence in the transmission by the electromagnetic radiation with a large wavelength area generated and emitted in said transmitting means

There is a technical problem in being able to understand the significance of, the advantages related to, and/or the technical measures and considerations which will be required for letting this bandpass filter at that time, by its construction and by chosen angles of incidence or similar, be adapted to have separated a first chosen spectral element and/or a first wavelength component from a second chosen spectral element and/or a second wavelength component within one and the same transmitted electromagnetic radiation.

There is a technical problem in being able to understand the significance of, the advantages related to, and/or the technical measures and considerations which will be required for letting said unit be adapted electrically to be able to detect an occurring radiation intensity over an opto-electric detector, said intensity being valid for more than one wavelength component and/or one spectral element.

There is a technical problem in being able to understand the significance of, the advantages related to, and/or the technical measures and considerations which will be required for having arranged adjacent to said bandpass filter an opening or a window limiting the diverging angle of the transmitted electromagnetic radiation.

There is a technical problem in being able to understand the significance of, the advantages related to, and/or the technical measures and considerations which will be required for letting said opening or window be oriented before and/or after a utilized bandpass filter, counted in the direction of radiation.

There is a technical problem in being able to understand the significance of, the advantages related to, and/or the technical measures and considerations which will be required for letting the optical (electromagnetic) bandpass filter be adapted to be capable of deflecting an incident and transmitted optical or electromagnetic radiation to at least two different optical and predetermined angles of reflection or outgoing angles, each one being applicable for narrow wavelength components and/or spectral elements.

There is a technical problem in being able to understand the significance of, the advantages related to, and/or the technical measures and considerations which will be required for letting said angles of reflection or outgoing angles for the narrow wavelength components and their radiation to be related exactly to a main angle of the incoming electromagnetic radiation which over its associated detector unit is to become the object of an analysis in the unit performing the spectral analysis.

There is a technical problem in being able to understand the significance of, the advantages related to, and/or the technical measures and considerations which will be required for letting one and the same bandpass filter be adapted to receive one and the same transmitted and incoming electromagnetic radiation, in which radiation two (or more) different and selected wavelength components or spectral elements occur in any case.

There is a technical problem in being able to understand the significance of, the advantages related to, and/or the technical measures and considerations which will be required for letting a number of bandpass filters selected beforehand be adapted to receive individual or the same transmitted electromagnetic radiation, in which radiation or radiations at least two different wavelength components or spectral elements occur.

There is a technical problem in being able to understand the significance of, the advantages related to, and/or the technical measures and considerations which will be required for indicating, for each or each selected angle of reflection or outgoing angle of the radiations, the existence of an opto-electric detector which is adapted to analyse its electrically associated wave-length component(s) or its associated spectral element(s) in its associated unit performing the spectral analysis.

There is a technical problem in being able to understand the significance of, the advantages related to, and/or the technical measures and considerations which will be required for as said optical bandpass filter selecting filter acting on optical interference.

There is a technical problem in being able to understand the significance of, the advantages related to, and/or the technical measures and considerations which will be required for letting said opening or window, said bandpass filter and/or included channels related to said unit performing the spectral analysis be coordinated to a means receiving and/or sensing the same signals.

There is a technical problem in being able to understand the significance of, the advantages related to, and/or the technical measures and considerations which will be required for letting said opening or window, said bandpass filter and said channels be coordinated to one and the same discrete receiver unit.

There is a technical problem in being able to understand the significance of, the advantages related to, and/or the technical measures and considerations which will be required for letting determine an instantaneously occurring concentration of a gas as carbon dioxide (CO₂).

There is a technical problem in being able to understand the significance of, the advantages related to, and/or the technical measures and considerations which will be required for letting an end portion of the limited space facing the sensing means exhibit a surface section reflecting electromagnetic radiation for deflecting radiation portions obliquely towards one or more bandpass filters lying outside of the limited space and/or wavelength-significant detectors.

### The Solution

Thus, the present invention takes as its starting point the known technology mentioned by way of introduction and based on an arrangement adapted for a spectral analysis of gas concentrations having a transmitting means adapted for an electromagnetic radiation, in accordance with the preamble of the following patent claim 1.

In addition to said transmitting means the arrangement is for gas test analysing to indicate a limited space, in the form of a cavity, serving as a measuring cell intended for the sample of gas and intended to be able to define an optical measuring distance or path, a sensing means for said electromagnetic radiation passing said optical measuring distance from said transmitting means, and a unit connected at least to said sensing means and performing spectral analysis, wherein said mentioned means sensing the electromagnetic radiation is adapted to be sensitive of the electromagnetic radiation which is intended to fall within a spectral area whose selected wavelength component(s) and/or spectral element(s) is/are to become subjects of an analysis in the unit performing the spectral analysis for determining in this unit the relative intensity of radiation of the wave-length component or the spectral element.

In order to solve one or more of the technical problems mentioned above the present invention more specifically indicates that the technology thus known is to be supplemented by letting said gas in said measuring chamber be placed under an overpressure chosen beforehand and wherein an achieved result, depending on one or more wavelengths being absorbed in the measuring chamber or cell, is compensated over a correction circuit for the selected overpressure such as against atmospheric pressure.

Moreover the present invention is disclosing required for modifying said transmitting means in the form of IR light to be maintained as constant or at least essential constant and that the pressures of concentrations of gas are set to vary, that a modulated concentration of gas is adapted for creating or generating one or more differential signals, whereby a static IR signal related to the environment is to be subtracted away in a chosen signal processing.

As preferred embodiments falling within the frame of the present invention it is in addition indicated that the overpressure is to be adapted and chosen responsive to an absorption capability valid at the chosen overpressure for a chosen gas and/or gas mixture.

The correction circuit cooperates with a correction unit having an absorption capacity/pressure formula for a circuit determining a chosen gas or gas mixture.

The overpressure chosen beforehand may be generated by a mechanical means, wherein said means can consist of an arrangement of a piston and a cylinder, whose piston is displaceable positioned between associated turning points alternatively having the mechanical means consist of a magnetic body oriented in the measuring cell, to which body an oscillating movement can be provided by a surrounding electric circuit.

According to the invention the frequency of a chosen change of overpressure is indicated as being chosen between 1 and 50 Hertz, such as around 25-35 Hertz.

It has turned out that the measuring chamber should be adapted to a volume of 0.5 to 3.0 cm³, such as around 0.8-1.2 cm³, and that the increase of pressure can be chosen to between 1:2 and 1:10, such as around 1:4 to 1:6.

More particularly it is indicated that the correction circuit should be adapted to provide a correction value of the gas concentration related to an instantaneous atmospheric pressure.

In accordance with the present invention it is further indicated that said transmitted electromagnetic radiation can, between said transmitting means and said sensing means, be adapted to pass an optical bandpass filter adapted to frequency and/or wavelength, said bandpass filter being structured and/or constructed for being able to offer a wavelength dependent of the angle of incidence in the transmission of the electromagnetic radiation generated by said transmitting means.

This bandpass filter is then adapted to separate a first chosen wavelength component(s) or a narrow area or a first chosen spectral element(s) from a second chosen wavelength component(s) or a narrow area or a second chosen spectral element(s) within the transmitted electromagnetic radiation and said unit is adapted for being capable of detecting occurring radiation intensities from more than one such spectral element over one or more opto-electric detectors.

As proposed embodiments falling within the frame of the basic concept of the present invention it is also indicated that adjacent to said bandpass filter there is to be disposed an opening or a window, limiting the dispersion angle of the transmitted electromagnetic radiation.

Furthermore it is indicated that said opening or window, counted in the direction of radiation, should be oriented in the direction of transmission, counted immediately before and/or after the used optical bandpass filter.

The optical bandpass filter is here adapted for letting an incident electromagnetic radiation be deflected into at least two different predetermined angles of reflection or outgoing angles of the electromagnetic radiations.

More specifically it is indicated that one and the same bandpass filter is to be adapted to receive one and the same electromagnetic radiation, within which radiation in any case at least two different wavelength components or spectral elements fall.

For each of or for each selected deflecting or outgoing angle of the radiation there is an opto-electric detector, which then is so adapted that it in its unit performing the spectral analysis, analyses its associated and by the unit received wavelength components or its associated spectral elements.

As said optical bandpass filter it may to advantage be selected a filter active on the basis of optical interference.

Said opening or window, said optical bandpass filter and/or included channels related to said unit performing said spectral analysis are coordinated to means receiving and/or sensing one and the same signals.

In the concept of the invention evaluation of the existence of and a concentration of carbon dioxide (CO₂), as in air or in exhaled air, is included.

The end section of the limited space facing the sensing means exhibits a surface section reflecting the electromagnetic radiation for deflecting the electromagnetic radiation obliquely towards an adjacent bandpass filter.

A ray of light (in the form a narrow electromagnetic bundle of radiation) or a chosen portion of light rays may to advantage be adapted so as to be directly directed at a right angle towards an opto-electric detector from a transmitting means.

### Advantages

The advantages that primarily must be considered to be characterizing of the present invention and the thereby indicated specific significant characteristics are that hereby there have been created prerequisites for, in an arrangement adapted for spectral analysis, a transmitting means adapted for electromagnetic radiation, a space, and a sensing means for said electromagnetic radiation from said transmitting means, and a, at least to said sensing means, connected unit performing the spectral analysis, wherein the mentioned means sensing the electromagnetic radiation is to be adapted sensitively for the electromagnetic radiation passing the filter and being intended to fall within a spectral area, whose selected wavelength components and/or spectral elements are to become the object of an analysis in the unit performing the spectral analysis for within this unit, by various calculations, determining the relative radiation intensity of the spectral element for compressed gas concentrations, indicating that said gas within said measuring chamber is to be placed under a predetermined overpressure, whereby a delivered result, depending on one or more wavelengths, being absorbed in the measuring chamber, is compensated for the selected overpressure by a correction circuit.

It is further proposed that said transmitted electromagnetic radiation is to be adapted to pass between said transmitting means and said sensing means, an adapted and/or constructed optical bandpass filter, with said bandpass filter being structured for being capable of offering a wavelength dependent of the angle of incidence for transmission of the electromagnetic radiation generated and sent out from said transmitting means.

Moreover the present invention is disclosing to modify said transmitting means in the form of IR light (Infra Red light) to be maintained as constant or at least essential as constant and that the pressures of concentrations of gas are set to vary and that a modulated concentration of gas is adapted for creating or generating a differential signal, whereby a static IR signal of the environment can be subtracted away in a chosen signal processing.

The subject matter that primarily can be considered to be characterizing of the present invention is disclosed within the characterizing portion of the following patent claim 1.

### SHORT DESCRIPTION OF THE DRAWINGS

Basic principles for enabling evaluation of measurement accuracy with small concentrations of gas and presently proposed embodiments exhibiting the significant characteristics related to this invention will now be described more specifically for exemplification purposes with reference to the accompanying drawings, in which;

FIG. 1 illustrates in A a time-related sequence for testing a gas with different e related concentrations,

FIG. 1 illustrates in B time-related signal responses from signal sequences of an opto-electric IR-detector (Infra Red detector),

FIG. 1 illustrates in C time-related measuring results calculated by a gas meter or measuring unit from signal sequence, illustrated in FIG. 1B,

FIG. 2 shows the principle of a measuring arrangement adapted for compressed concentrations of gas, or gas mixtures, such as small concentrations of gas, while utilizing NDIR technology with a transmitting means, a limited pressure resistant space adapted for a sample of said gas, a sensing means and a unit performing spectral analysis with its allotted display unit, and with a correction circuit compensating for the prevailing absorption ability/pressure,

FIG. 3 shows the principle of a known receiver unit or a sensing means in a one-channel-measuring (Single Beam NDIR Technology) process and in a two-channel measuring (Dual Beam NDIR Technology) process,

FIG. 4 shows an optical arrangement bearing reference to the present invention,

FIG. 5 and its illustration “D” has the purpose of illustrating time-related signal responses of an IR detector in an IR gas metering unit, according to FIGS. 1B and 1C but modified with an external partial system for compressing the measuring gas,

FIG. 5 and its illustration “E” is a time-related illustration of a measuring result calculated by a gas meter from the signal sequence illustrated in FIG. 5D,

FIG. 5 and its illustration “F” illustrates time-related signal responses for an IR detector in an IR gas measuring unit in which the IR light source is adapted to emit a constant IR light and instead exposing a modulation by varying the pressure of the measuring gas, and

FIG. 5 and its illustration “G” illustrates time-related a measuring result calculated by a gas measuring unit on the basis of the signal sequences illustrated in FIG. 5F.

### BRIEF DESCRIPTION OF KNOWN CONSIDERATIONS

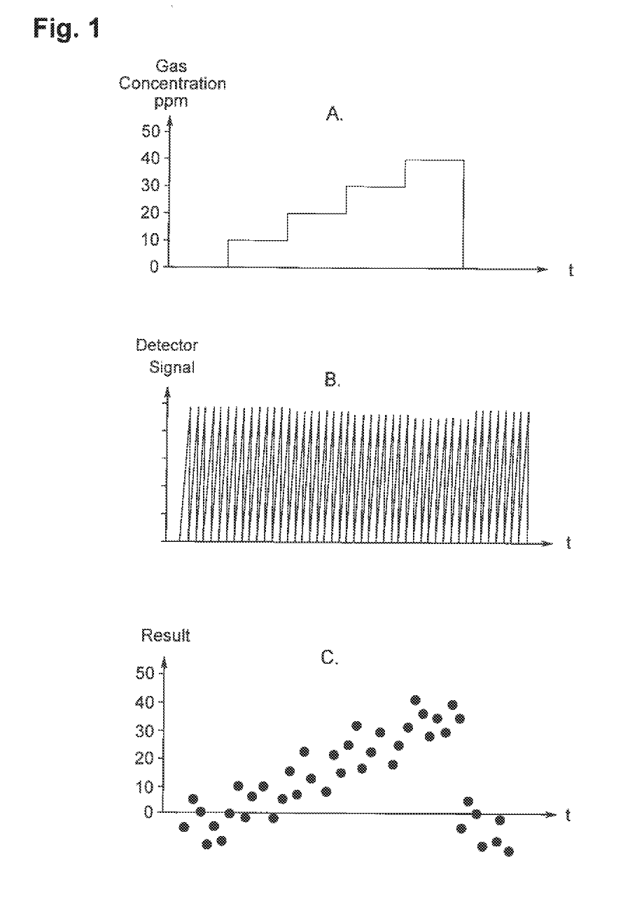

FIGS. 1A to 1C have the purpose of schematically illustrating a test gas sequence of different measuring principles while utilizing IR detectors in an NDIR gas metering unit.

Hence, FIG. 1A illustrates contemplated test gas sequences and has the purpose of illustrating the practical measuring accuracy of different measuring principles as related to the concentration of measured gas samples.

FIG. 1B illustrates signal responses of an IR detector in a traditional classical NDIR gas metering or measuring unit in which a utilized IR light source flashes with the purpose of generating a differential signal so that a static IR light of the surroundings can be subtracted in a following signal processing.

The small, hardly visible weakening of the amplitude of the signals in increasing gas concentrations should be noted here.

FIG. 1C illustrates the developed measuring result of the signal sequence in accordance with FIG. 1B, wherein the resolution in this illustration is limited to approximately ±7 ppm of the noise level of the system, which makes the step increases in the test gas sequence basically impossible to discern.

This also shows that the result of the measuring is affected i.e. by the detector's great sensitivity for thermal variations.

In order to minimize this negative influence the IR light source is made to flash at a frequency “f” as high as the included components permit (frequency “f” is typically a single Hertz), but remaining thermal noise is transferred as noise superimposed on the developed measuring values.

Utilizing a stronger IR light source to defeat the noise normally provides a solution, however a stronger emitter must have more mass so as not to burn up and a stronger emitter with more mass brings about a lower possibility of modulation, i.e. what is gained in increased power is lost with a lower modulation frequency (the noise decreases by a factor “1/f”).

### DESCRIPTION OF THE PRESENTLY PROPOSED EMBODIMENT

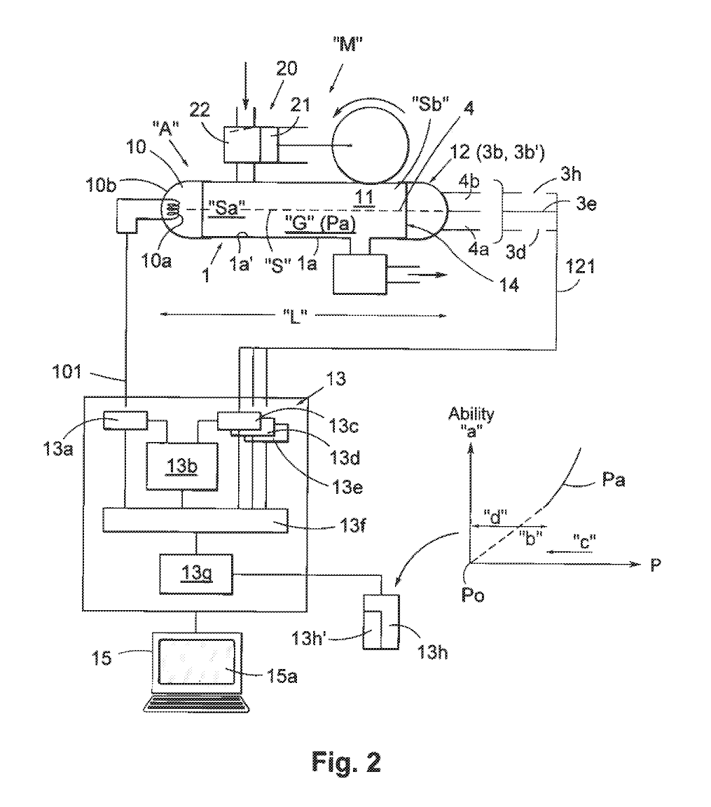

By way of introduction it should be pointed out that in the following description of a presently proposed embodiment which exhibits the significant characteristics related to the invention and which is clarified by the annexed FIGS. 2 to 5 shown in the accompanying drawings we have chosen terms and specific terminology with the purpose of thereby primarily clarifying the inventive concept itself.

However, in this connection it should be noted that the terms chosen here should not be seen as limiting solely to the terms utilized and chosen here, and it goes without saying that each term thus chosen is to be interpreted so that in addition it will be able to comprise all technical equivalents that function in the same or substantially the same manner so as to thereby achieve the same or essentially the same purpose and/or technical result.

Thus, with reference to the enclosed FIGS. 2 to 5, respectively, the prerequisites of the present invention are shown schematically and in detail with the significant qualities related to the invention concretized by the now proposed and in the following more specifically described embodiment.

Hence, FIG. 2 schematically shows the principles of an arrangement “A” adapted for spectral analysis and having a transmitting means 10 adapted for electromagnetic radiation “S” with a large wavelength interval, as well as a limited space 11 in the form of a cavity serving as an adapted measuring cell and its related measuring path “L” for a sample “G” of gas subjected to an overpressure (Pa) and intended to be able to define an exact optical measuring distance or path “L”.

Furthermore a sensing means 12 (3b, 3b′) for said electromagnetic radiation “S” passing said optical measuring distance “L” from said transmitting means 10 is illustrated as well as a unit 13 performing the spectral analysis and under all circumstances connected to said sensing means 12 and therein included opto-electric detectors 3b, over a connecting lead 121.

Furthermore the mentioned means 12 and therewith associated detectors 3b, 3b′ sensing the electromagnetic radiation “S” are to be adapted sensitively to the electromagnetic radiations which are intended to fall within a spectral area whose selected wavelength component(s) or spectral element(s) is/are to be the subjects of an analysis in the unit 13 performing the spectral analysis for primarily in this unit 13 calculating and determining the relative intensity of radiation of the received spectral element(s).

Said emitted electromagnetic radiation “S” between said transmitting means 10 and said sensing means 12 is adapted to pass towards and selected pass a bandpass filter, such as an optical bandpass filter 14.

It is to be noted that the present invention is base upon a modification of said transmitting means 10 in the form of IR light source to be maintained as constant or at least essential constant and that the pressures of concentrations of gas (Pa) are set to time-wise vary and that a modulated concentration of gas is adapted for creating or generating a differential signal, whereby a static IR signal of the environment can be subtracted away in a chosen signal processing.

With the expression “constant” or “essential constant” it is within the scope of the present invention to generate a pulsed IR light, with each pulse under evaluation having the same or essential the same intensity or amplitude or a constant IR-light during the measurement sequence.

Such bandpass filter 14 is, according to FIG. 4, structured and/or constructed so as to be able to offer a wavelength dependent on the angle of incidence in the transmission of the electromagnetic radiation “S” generated by said transmitting means 10.

This bandpass filter 14 is then adapted to separate, by a chosen angle of incidence, a first chosen spectral element 4a from a second chosen spectral element 4b, and two opto-electric detectors 3b and 3b′ are both connected to said unit 13 which is adapted with modules in order to be able to detect an occurring radiation intensity for more than one such spectral element.

The unit 13 performing the spectral analysis exhibits a transmitter module 13a for electromagnetic radiation “S” over a connecting lead 101 and controlled and activated by a central unit 13b and a number of signal receiving modules 13c, 13d and 13e, respectively, serving as detector transmitting and/or converting signals, are also connected to the central unit 13b, but over the connecting lead 121.

Over a circuit 13f comparing signals, an electromagnetic radiation “Sa” transmitted from the transmitting means 10 can be compared with a received specific electromagnetic radiation “Sb” in unit 13.

The evaluated and calculated result in the central unit 13b can then be transferred to a display unit 15 as a graph 15a.

More particularly FIG. 2 illustrates an application with an absorption cuvette, inside of which cuvette the gas “G” sample which with the assistance of the electromagnetic radiation “Sa” or considered as a radiation bundle 4 is to be analysed, wherein the radiation “Sa” is transmitted by an emitter unit 10a and is received by opto-electric detectors, such as 3b, 3b′.

This emitter unit 10a can consist of a source of radiation and a collimator that coordinates light rays and has the purpose of as effectively as possible collecting the emitted radiation “Sa” with its radiation bundle 4 and directing the same through the length “L” of the absorption cuvette towards detectors 3b, 3b′ or receiver 12.

The emitter unit 10a can here be given a form of a glowing wire in a glass bulb filled with gas or gas-evacuated, i.e. an incandescent lamp, or a heated resistor on a ceramic substrate or on a thin membrane created by means of silicon technology and micromechanics or a light emission diode having a well-balanced emission spectrum.

In accordance with the instructions of the invention emitter unit 10a is to send out an emission “Sa” of radiation bundles 4 which at least must comprise all of the wavelengths whose intensities are to be detected opto-electrically in individual detectors 3b, 3b′ and are to be evaluated in unit 13.

The absorption cuvette can then be designed in different ways depending on the chosen application, the chosen measuring accuracy, the manner in which the measuring gas “G” can be expected to be collected, via overpressure, etc.

In certain applications the space 11 of the absorption cuvette can simultaneously constitute the mechanical frame on which emitter unit 10 and receiver 12 are firmly mounted.

The detectors 3b, 3b′ of receiver unit 12 are adapted to create the opto-electric wavelength dependent electric signals which later are to become the subject of a calculating analysis in the unit 13 performing the spectral analysis.

Such units 13 are well known in this technical field and are therefore not descrybed in detail here.

Said unit 13 is intended to calculate the result that shows a relevant gas concentration and/or a gas and/or a mixture of gases.

In order to be able to offer an increase of necessary measuring sensitivity, such as to increase the length of the measuring distance or path or the absorption distance “L”, this can be realized by different optical arrangements, such as with multiple reflection passages back and forth within a measuring cell or the limited space 11, so called multipass cells.

In order in addition to be able to gather or concentrate the emitted electromagnetic radiation “Sa” that the collimator or reflector 10b cannot entirely collimate in the desired and correct direction it is possible to utilize, in known manner, absorption cells having reflecting inside surfaces and having their geometry designed such, that the light from emitter unit 10a is led forward towards receiver unit 12, such as a waveguide.

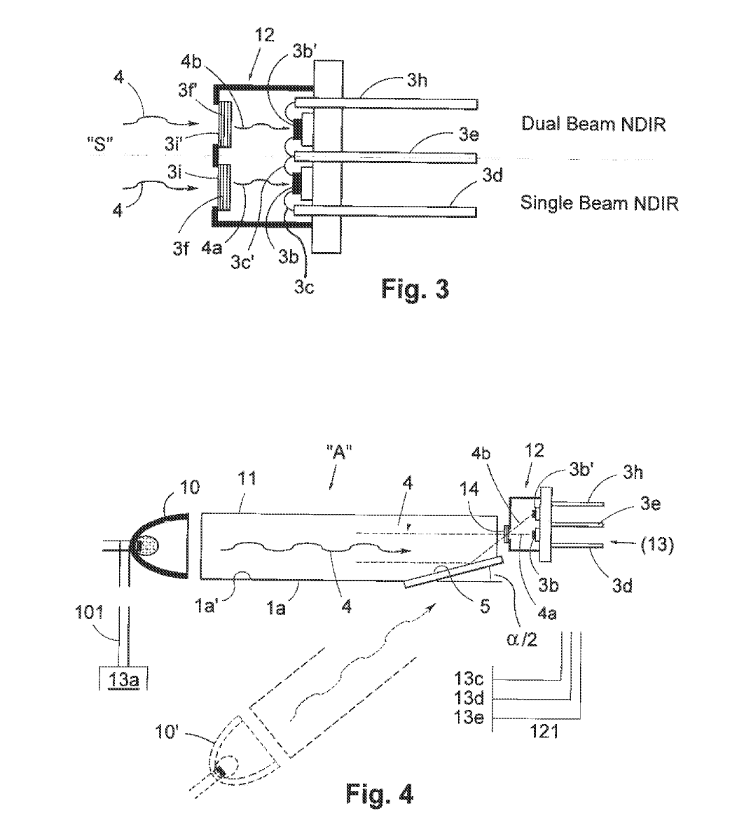

FIG. 3 schematically illustrates a known receiver unit 12 adapted for a one-channel measuring technique, wherein the emitted incoming light ray 4 is filtered optically through an interference filter 3f, which in this example is mounted as a lower window on the enclosure 12a of the receiver unit 12 in connection with an opening (an aperture) 3i in the enclosure 12a so that solely electromagnetic radiation or light 4a, within a very narrow and well-defined spectral interval, passes filter 3f and reaches an opto-electric detector 3b, which is sensitive to this radiation.

Opening 3i has the function of filtering specially, i.e. solely letting in towards detector element 3b the electromagnetic radiation 4, 4a which connects to the direction from emitter unit 10 and to suppress light and radiation from other directions which otherwise will be able to contribute negatively and disturbingly on the calculated result within the unit 13.

Therefore, walls 1a, 1a′ (FIG. 2) comprise a shielding against the surrounding world as well as the structure of the receiver unit 12.

Detector element 3b can for example be of the type of a photo diode, quantum detector, pyroelectric detector or some other form of thermal detectors for opto-electric conversion.

It is important that the opto-electric detector 3b has the ability of generating some kind or some type of electric signals whose size and shape are to be dependent of and to correspond to the intensity of the radiation 4a and its frequency range passing through opening 3i and the filter 3f.

By means of illustrated electric connectors or leds 3c, 3c′ these electric signals are transferred to two measuring prongs 3d and 3e of the receiver unit 12, from which a following amplifier stage (not shown) in unit 13 and/or other electronics/computer processing refines the measuring signal to a final result, which may be evaluated, for example visible as a graph 15a on a display unit 15.

If measuring of gas is to occur in accordance with NDIR technology, the wavelength of filter transmission 4a is chosen such that it coincides with some absorption wavelength, which is characteristic of the matter for which the concentration of gas is to be measured.

FIG. 3 now also shows schematically a known receiver unit 12 for a two-channel measuring technique, and this receiver unit 12 has, in addition to what has been shown and described, been provided with an additional opening 3i′ with an interference filter 3f′ lying behind and with its associated opto-electric detector element 3b′.

Filter 3f′ is here chosen with an transmission wavelength 4b than that of the filter 3f, and therefore the selected IR light 4b will have another wavelength than that of the selected IR light 4a.

The corresponding, into electrically measurable signals converted signals on connecting pins 3h and 3e for rays 4b with their wavelengths and 3d and 3e, respectively, for rays 4a with their wavelengths thereby provide information of how two momentaneous light intensities differ between the two chosen different wavelength component(s) or spectral element(s) belonging to rays 4a and 4b.

Short-time variations in the inwardly radiated intensity of the electromagnetic radiation “S” or the light bundles “Sa”, as designated 4, which run the risk of distorting an accurate evaluation of the measuring signals on leads 121, can be utilized and regulated away completely if one of the measuring channels is used as an intensity reference in a chosen signal-neutral wavelength.

With renewed reference to FIG. 2, more specifically it is illustrated an arrangement “M” to compress the sample of gas and increase the value of the evaluated concentration of gas to more accurately analyzable values.

The invention is in his respect to be exemplified with small values of the concentration of gas.

Said gas “G” in said measuring chamber 11 is placed under a predetermined overpressure (Pa), wherein an emitted result on a display 15a, depending on one or more wavelengths being absorbed in measuring chamber 11, is compensated for the influence of the chosen overpressure (Pa) over a correction circuit 13g.

The invention indicates that the overpressure (Pa) is adapted and chosen in dependence of the absorption ability at the chosen overpressure for a selected gas and/or gas mixture.

Correction circuit 13g cooperates with a correction unit 13h having a circuit 13h′ determining the ability of absorption/pressure for each selected gas or gas mixture, with the relationship of the absorption ability to the chosen pressure Pa being illustrated in an adjacent “P/a”-graph.

Hence, correction circuit 13g is adapted to reduce an evaluated fictive gas concentration with a stored or an evaluated value,

It should be noted that the “Na”-graph illustrated here is to be seen as one of among several graphs valid for their gas or gas mixture.

Hence, the ability “a” of absorption is “0” at the atmospheric pressure of “Po” and exhibits an initial area “d” with very uncertain results, followed by an area “b” with somewhat uncertain results, for continuing to a gas concentration area “c” having good results.

The overpressure Pa chosen beforehand can be generated by mechanical means or an arrangement “M”.

The mechanical means “M” is here illustrated to comprise an arrangement 20 with a piston and a cylinder in FIG. 2, where said piston 21 being movably positioned between associated turning points, with an upper turning point being shown. Cylinder 22 is in this case provided with valves cooperating with a four stroke motor for measuring a sample “G” of gas under pressure in the measuring chamber 11 with a selected overpressure (Pa).

The mechanical means may as an alternative consist of a magnetic body positioned in measuring cell 11 or a magnetic body related to the measuring cell, said body being given an oscillating motion by a surrounding electric circuit (not shown).

The frequency of a chosen change of overpressure via means “M” is selected to between 1 and 50 Hertz, such as around 25-35 Hertz.

Measuring chamber 11 is adapted to a volume of between 0.5 to 3.0 cm³, such as around 0.8-1.2 cm³.

The increase of pressure is dependent of the expected concentration of gas and is in a normal case to be chosen to between 1:2 and 1:10, such as around 1:4 to 1:6.

Correction circuit 13g is adapted to produce a reduced value of the concentration of gas to display unit 15 and its display 15a related to the atmospheric pressure.

FIG. 4 illustrates an additional optical arrangement “A′” in accordance with the principles of the invention.

Compared to the NDIR structure of FIG. 2 it is here indicated that the receiver unit 12 has been replaced by a structure with the purpose of having the lower detector element 3b directly illuminated by the light bundle 4a, which has passed (directly) through the upper half of measuring cell 11.

The upper detector element 3b′ will then be illuminated by the ray of light or light bundle 4b which passes (directly) through the lower half of the measuring cell 11 but which has been angled up towards detector 3b′ by a small reflecting mirror surface 5 being introduced.

Mirror surface 5 is here mounted at an angle of “α/2” with respect to the original direction of the propagation of the light 4 so that the angle of incidence towards the interference filter will have the value “α” desired for the arrangement, seemingly originated from the virtual image of emitter unit 10′ at the lower section of FIG. 4.

There are at that time a number of possible solutions of the arrangement “A” and variations thereof which on the one hand can generate the necessary angles of incidence for receiver unit 12 and on the other hand can indicate different means “M” for generating different pressures and different correction circuits 13g so as to thereby offer solutions of the arrangement associated with the invention.

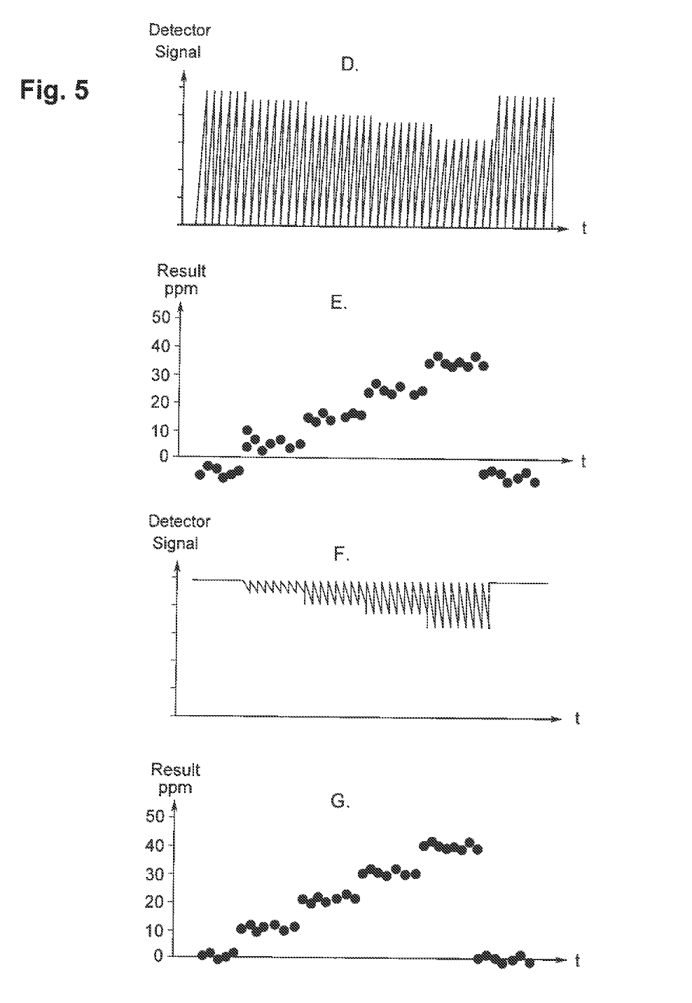

The invention, in accordance with the embodiment, shown in FIGS. 2 to 4, respectively, is additionally illustrated in FIG. 5 under the illustrations D to G, respectively.

Hence, FIG. 5D illustrates time-related signal responses of the IR detector in an IR gas measuring unit of the same type as a preceding one in FIGS. 1B and 1C but modified by an external partial system “M” for compressing the measuring gas “G”.

Note the more distinct weakening of the amplitude of the signal for this compressed gas mixture in increasing concentrations of gas.

FIG. 5E illustrates the calculated measuring results of the gas measuring unit from the signal sequence of FIG. 5D.

As a result of the much more distinct amplitude change in this case as a function of the concentration of test gas the amplification factor of the absorption calculations can be retained much lower than that in the first case, with the noise factor in this case becoming reduced to the corresponding degree and the different stages appearing more clearly.

However, note the zero point error, in this case, approximately −7 ppm, which now can be clearly seen.

The zero point error is one of the limitations of the accuracy, which is characteristic for classical NDIR technology.

In FIG. 5F signal responses of the IR detector in an IR gas measuring unit structured in accordance with the present invention are illustrated, wherein the IR light source is actuated to emit a “constant” IR light, and instead the desired modulation occurs over the pressure of the measuring gas with the purpose of generating a differential signal such, that a static IR light of the environment can be subtracted away in the following signal processing.

FIG. 5G illustrates the calculated measuring results of the gas measuring on the basis of the signal sequence in FIG. 5F.

It should be noted that a zero point error is lacking here, which a consequence of an AC signal is filtering.

Solely the absorption component is modulated by the pressure modulation, and hence the possible aging of the IR light source and the other optics solely effect the DC level of the signal.

By compressing the gas during the optical measuring the gas absorption “a” is increased in accordance with the P/a-graph of FIG. 2.

This effect depends on that more and more molecules then will interact with IR light when they are pushed in and passing a long measuring distance “L”:

The effectiveness of this process increases because of the mutual collisions of the molecules and in addition unlinearly with the pressure, which favourite's high pressure measuring.

By modulation of the gas compression during the optical measuring the absorption of gas is amplified at the same time as the zero point safety is set aside completely, as the AC component of the detector in this case will be directly proportional to the concentration of gas.

The signal/noise ratio can be improved additionally by this method by utilizing still more powerful IR emitters, as these light sources here are permitted to work without power modulation.

In addition there are possibilities of decreasing the “1/f” noise by operating at a still higher pneumatic modulation frequency.

The present invention is offering, for the solution of the technical problems mentioned, that said gas in said measuring cell is to be set under an overpressure chosen beforehand, and that a delivered result, depending on one or more wavelengths under absorption within the measuring cell, is over a correction circuit compensated down for the chosen overpressure, such as against the atmospheric pressure

Said transmitting means, in the form of IR light, is to be maintained at or regulated to a constant energy value during the sequence of compensation, even during pulsed IR light.

The pressures of concentrations of gas are set to vary within a predetermined concentration of gas, that a modulated concentration of gas is adapted for creating or generating a differential signal, whereby a static IR signal of the environment can be subtracted away in a chosen signal processing technique.

The invention is of course not restricted to the embodiment disclosed above as an example and it can be subjected to modifications within the frame of the inventive concept, which is illustrated in the following claims.

It should be particularly noted that each unit and/or circuit may be combined with each other illustrating unit and/or circuit within the framework of it being possible to achieve the desired technical function.

Although the invention primarily is intended to be applied at small concentrations of gas there is nothing that prevents applying the principles of the invention of higher concentrations of gas.

1. Arrangement adapted for spectral analysis of compressed, such as small, concentrations of gas having an IR-transmitting means adapted for electromagnetic radiation, a limited space, in the form of a cavity, serving as a measuring cell, adapted to said gas and intended to be able to define an optical measuring distance or path “L”, a sensing means for said electromagnetic radiation passing said optical measuring distance or path from said transmitting means, and a unit performing the spectral analysis and connected at least to said sensing means, wherein said means, sensing the electromagnetic radiation, is opto-electrically adapted sensitive to the electromagnetic radiation which is intended to fall within a spectral area whose selected wavelength component(s) or spectral element(s) is/are to become subject of an analysis within the unit performing the spectral analysis for determining in this unit, by means of calculations, the intensity of radiation of said spectral element(s), wherein said gas in said measuring cell is set under an overpressure (Pa) chosen beforehand, and that a delivered result, depending on one or more wavelengths under absorption in the measuring cell, is over a correction circuit compensated down for the chosen overpressure, such as against the atmospheric pressure, that said transmitting means, in the form of IR light, is maintained at or regulated towards a constant energy value, and that the pressure of concentrations of gas are set to vary, that a modulated concentration of gas is adapted for creating or generating a differential signal, whereby a static IR signal of the environment can be subtracted away in a chosen signal processing technique.

2. Arrangement in accordance with claim 1, wherein an external partial system is utilized for said concentration of gas over an overpressure.

3. Arrangement in accordance with claim 1, wherein a limited amplification factor for calculating absorption is utilized for reducing the effect of a noise factor.

4. Arrangement in accordance with claim 1, that wherein the calculation is concentrated towards reducing a zero point error, which would occur otherwise.

5. Arrangement in accordance with claim 1, wherein said transmitting means, in the form of IR light, is maintained constant and that the pressures of concentrations of gas are set to vary within predetermined values during a measuring sequence.

6. Arrangement in accordance with claim 1, wherein a modulated concentration of gas is adapted for creating or generating two or more differential signals, whereby a static IR signal, based upon the environmental gas concentration, is subtract^{e}d away in a chosen signal processing technique.

7. Arrangement in accordance with claim 1, wherein the overpressure is adapted and chosen in response to a good capability of absorption, valid at the chosen overpressure for a chosen gas and/or gas mixture.

8. Arrangement in accordance with claim 1, wherein the correction circuit is in cooperation with a correction unit having a circ it determining the capability/pressure of absorption for a selected gas or gas mixture.

9. Arrangement in accordance with claim 1, wherein the overpressure selected beforehand can be generated by the use of a mechanical means.

10. Arrangement in accordance with claim 9, wherein the mechanical means comprises an arrangement, including a piston and a cylinder, the piston thereof being displaceable by means between associated turning points.

11. Arrangement in accordance with claim 9, wherein the mechanical means comprises a magnetic body oriented inside the measuring cell, said body being allottable an oscillating movement of a surrounding electric circuit.

12. Arrangement in accordance with claim 10, wherein the frequency of a chosen change of overpressure is selected as between 1 and 50 Hertz, such as around 25-35 Hertz.

13. Arrangement in accordance with claim 1, wherein the measuring chamber is adapted to a volume of 0.5 to 3.0 cm³, such around 0.8-1.2 cm³.

14. An arrangement in ac accordance with any one of the preceding claims claim 1, wherein the increase of pressure is selected as between 1:2 and 1:10, such as around 1:4 to 1:6.

15. Arrangement in accordance with claim 1, wherein the correction circuit is adapted to calculate a reduced value with regard to a delivered measuring value of the measured concentration of gas related to the atmospheric pressure.

16. Arrangement in accordance with claim 1, wherein said electromagnetic radiation is adapted, between said transmitting means and said sensing means, to be permitted to pass an adapted optical bandpass filter, that the bandpass filter is structured and/or constructed for being able to offer a wavelength dependent of the angle of incidence for the transmission of the electromagnetic radiation generated by said transmitting means, with said bandpass filter being adapted to separate a first selected wavelength component(s) and/or a first selected spectral element(s) from a second selected wavelength component(s) and/or a second selected spectral element(s) for reception in individual onto-electric means or detectors and that said unit is adapted to be able to detect and calculate an occurring radiation intensity for more than one received wavelength component and/or one spectral element.

17. Arrangement in accordance with claim 1, wherein adjacent to said bandpass filter is disposed an opening or a window limiting a dispersion angle of the electromagnetic radiation.

18. Arrangement in accordance with claim 17, wherein said opening or window is oriented before and/or after said bandpass filter, counted in the direction of radiation.

19. Arrangement in accordance with claim 1, wherein in response to the relevant angle of incidence the bandpass filter is adapted to deflect an incoming electromagnetic radiation in at least one, preferably at least two different, electromagnetic and optical and predetermined outgoing angles

20. Arrangement in accordance with claim 1, wherein one and same bandpass filter is adapted to receive one and the same electromagnetic radiation, within which at least two different spectral elements fall.

21. Arrangement in accordance with claim 16, wherein for each or each selected angle allotted outgoing ray there is an opto-electric detector, which is adapted, by furnished electric signals and calculations, to the unit performing the spectral analysis, to have its associated spectral element analysed.

22. Arrangement in accordance with claim 16, wherein as said bandpass filter a filter active on optic interference is chosen.

23. Arrangement in accordance with claim 16, wherein said opening, said bandpass filter and/or included channels related to said unit performing said spectral analysis are coordinated to a receiving and/or sensing means for one and the same signals.

24. Arrangement in accordance with claim 16, wherein the concentration of carbon dioxide (CO₂) is evaluated and is presented, such as a graph on a display unit.

25. Arrangement in accordance with claim 16, wherein the end section of the limited space facing the sensing means exhibits a surface section reflecting electromagnetic signals for deflecting the transmitted electromagnetic signals obliquely towards one or more opto-electric detectors.
